(19) United States
(12) Patent Application Publication
(10) Pub. No.: US 2012/0016948 A1
(43) Pub. Date: Jan. 19, 2012

(54) SOCIAL NETWORK ACTIVITY MONITORING AND AUTOMATED REACTION

(75) Inventor: Raj Sinha, West Orange, NJ (US)

(73) Assignee: Avaya Inc., Basking Ridge, NJ (US)

(21) Appl. No.: 12/837,090

(22) Filed: Jul. 15, 2010

(51) Int. Cl. G06F 15/16

(52) U.S. Cl. 709/207; 706/20

(57) ABSTRACT

Methods and systems provided herein provide an enterprise with the ability to detect the occurrence of an event and quickly respond to the same. In particular, events can be detected by analyzing multiple messages which were retrieved from social media networks and converted into work items. If the analysis of the work items results in the detection of a trend or similarity among the work items, then it may be inferred that an event has or is occurring.

### FIELD OF THE INVENTION

The present invention is generally directed toward contact centers and specifically directed toward operating a contact center configured to conduct social media interactions.

### BACKGROUND

With the proliferation of the Internet has also come the proliferation of blogging and social networking. A social network is a social structure made of individuals (or organizations) called “nodes,” which are tied (connected) by one or more specific types of interdependency, such as friendship, kinship, financial exchange, dislike, etc. A social network service focuses on building online communities of people who share interests and/or activities, or who are interested in exploring the interests and activities of others. Most social network services are web based and provide a variety of ways for users to interact, such as e-mail and instant messaging services.

Social networking has encouraged new ways to communicate and share information. Social networking websites are being used regularly by millions of people.

While it could be said that email and websites have most of the essential elements of social network services, the idea of proprietary encapsulated services has gained popular uptake recently.

The main types of social networking services are those which contain category divisions (such as former school-year or classmates), means to connect with friends (usually with self-description pages) and a recommendation system linked to trust. One currently popular social network allows users to post a short message about what they are currently doing to allow their followers to keep up with their day-to-day activity. Other social networks and blogs provide a forum for people to discuss certain topics. Sometimes the collective activity of many users on the social network or different social network sites may provide an indication that a certain event has occurred. There is currently no mechanism available to identify that such an event has occurred and respond to that event.

### SUMMARY

It is with respect to the above issues and other problems that the embodiments presented herein were contemplated.

Consider a situation where multiple social network users have the ability to post messages to their social network page with their mobile communication device. Social networks are typically used as a mechanism which allows a user to share their daily experiences with other users. If an event occurs in a certain area (e.g., an earthquake, tornado, or accident occurs) it is likely that one or more users of a particular social network or multiple social networks may generate a post to their social network account that is viewable by the public (or a subset of the public that has subscribed to such posts or has access to such posts via knowing an appropriate password).

One aspect of the present invention is to provide an event detection module that can monitor the activity of multiple users across multiple Internet sites (e.g., Social Networking sites, blogs, discussion sites, product sales sites, company feedback sites, etc.) and determine if an event has occurred. If the event detection module determines that an event has occurred (usually by detecting a spike in keyword usage or determining that keyword/phrase usage has exceeded a particular threshold), then an event reaction module may be invoked that responds to the detected event.

In some embodiments, the event reaction module may generate an automated response to the event based on the type of event that has been detected. In other embodiments, the event reaction module may generate and send a message to a human user that can define the types of actions that should be performed by the event reaction module to respond to the event.

Consider the following, non limiting, use case. An earthquake occurs and multiple people begin posting about this particular event on their social network of choice. The event detection module may detect a spike in usage of the term(s) “earthquake” “earth quake” “shake”, or alternates or misspellings thereof. The event detection module or a location API may also be adapted to detect that the spike in usage occurred among users at a particular location, thereby enabling the event detection module to determine an estimated location of the event. This information can be provided to the event reaction module which analyzes the location and type of the event (e.g., earthquake in San Francisco, Calif.) and determines suitable responses to that event. In one embodiment, the event reaction module may retrieve a set of “how to” instructions for acting in the earthquake. The instructions may be provided back to all users that have just created a posting about the event. The instructions may also be provided to users that have not posted about the event but are known to be close to the event.

In another use case, the event detection module may be adapted to detect a spike in discussions about a particular product. The event detection module may also determine that the spike is related to a possible product malfunction or bug. For example, the event detection module may detect a certain number of postings or responses to postings on a website or collection of websites that indicate that a particular product (a first keyword) is having a particular problem/bug/malfunction (a second keyword). The event detection module may invoke the event reaction module to generate an automated reaction to the event. The automated reaction may include obtaining a software patch or plug-in that fixes the bug and providing the patch to the users that have posted about the bug as well as any other users that are known to have the product and, therefore, encountered the same problem. In a more simple response, the event reaction module may generate an automated reply post on the social network site, blog, or site that responds to the complaint posting. The reply post may have some canned language “The problem is being addressed . . . here is a possible solution” or some other content that shows the company is addressing their customers' concerns. Embodiments of the present invention may also be utilized to determine whether events have occurred related to market conditions (e.g., stock market events, bond market conditions, commodity market conditions, etc.).

In some embodiments, the functionality of the event reaction module and event detection module may be combined into a single module.

In accordance with at least some embodiments of the present invention, a method is provided that generally comprises:

receiving a plurality work items in a contact center;

analyzing the plurality of work items for trends or similarities;

detecting a trend or similarity among the plurality of work items;

classifying the trend or similarity as an event; and

generating a response to the event, wherein the response to the event is incorporated into a response to each of the plurality of work items.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “stalking” means the process of determining a person is presently using a social media network and can be contacted on that social media network in real time.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the invention is considered to include a tangible storage medium and prior art-recognized equivalents and successor media, in which the software implementations of the present invention are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

### BRIEF DESCRIPTION OF THE DRAWINGS

The present disclosure is described in conjunction with the appended figures:

FIG. 1 is a block diagram of an embodiment of a communication system operable to interact with persons using social media networks;

FIG. 2A is a block diagram of an embodiment of a social media gateway;

FIG. 2B is a block diagram of an embodiment of a dialog system;

FIG. 3 is a block diagram of an embodiment of a data structure;

FIG. 4 is a flow diagram of an embodiment of a process for responding to social media interactions;

FIG. 5 is a block diagram of an embodiment of a computing environment; and

FIG. 6 is a block diagram of an embodiment of a computing system.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

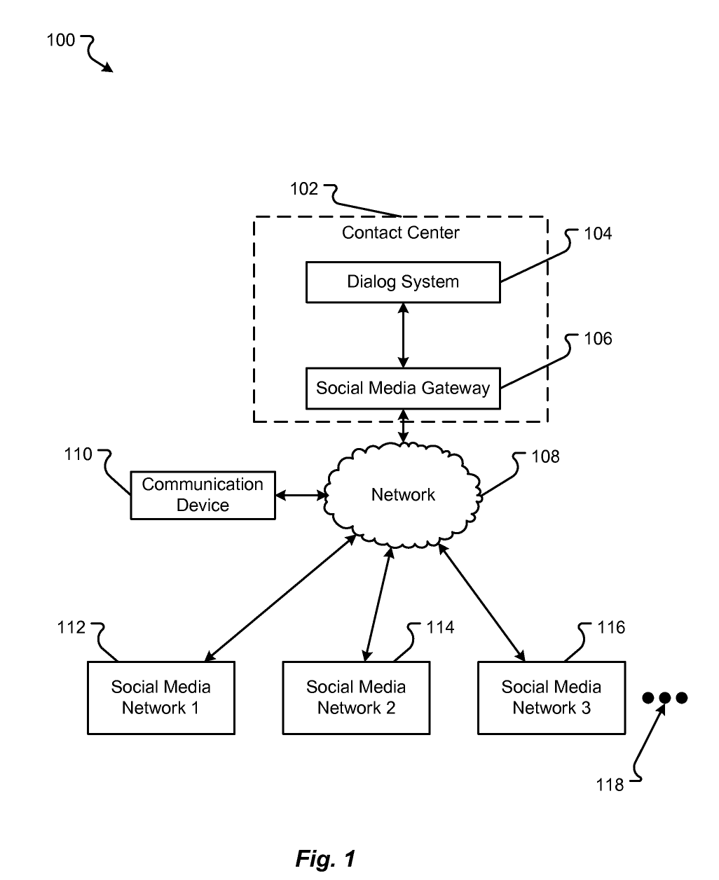

A communication system 100, for detecting events and interacting with known and/or potential persons affected by the detected event using social media is shown in FIG. 1. The communication system 100 can include a contact center 102, a network 108, and one or more types of social media networks or systems, such as social media network 1 112, social media network 2 114, and social media network 3 116. Social media networks 1 112, 2 114, and/or 3 116 can be any social media or different types of information sources including, but not limited to, networks, websites, or computer enabled systems. For example, a social media network may be MySpace, Facebook, Twitter, Linked-In, Spoke, or other similar computer enabled systems or websites. The communication system 100 can communicate with more or fewer social media networks 112, 114, and/or 116 than those shown FIG. 1, as represented by ellipses 118. The other types of information sources which may be monitored by the contact center 102 include RSS feeds, webfeeds, and the like.

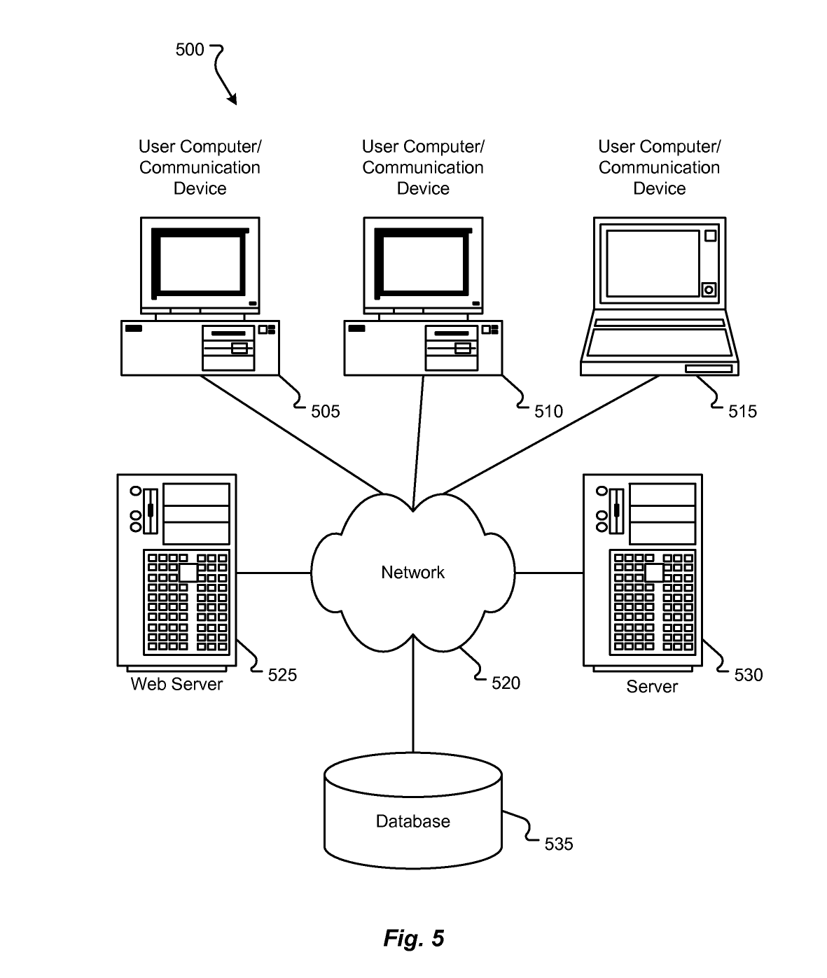

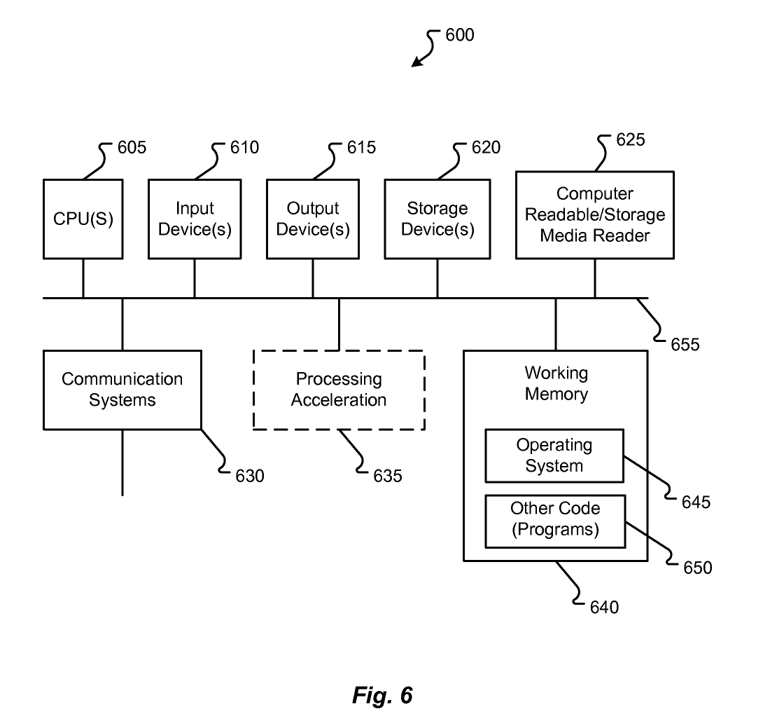

The network 108 can be any network or system operable to allow communication between the contact center 102 and the one or more social media networks 112, 114, and/or 116. The network 108 can represent any communication system, whether wired and/or wireless, using any protocol and/or format. One exemplary implementation of the network 108 is the Internet. The network 108 provides communication capability for the contact center 102 to communicate with sites (i.e., web-servers or server clusters via http formatted request and response protocols) corresponding to the one or more social media networks 112, 114, and/or 116. However, the network 108 can represent two or more networks of the same or different type, where each network is a different communication system using different communication protocols and/or formats and/or different hardware and software. For example, network 108 can be a wide area network, local area network, the Internet, a cellular telephone network, or some other type of communication system. The network may be as described in conjunction with FIGS. 5 and 6.

A contact center 102 can be a system owned and operated by an enterprise that can communicate with one or more persons that use social media networking sites. In some embodiments, the enterprise administering the contact center 102 may offer products and/or services to various customers. In some embodiments, the contact center 102 may be utilized to offer the products and/or services. In some embodiments, the contact center 102 may be utilized to provide customer support and related services for previously sold products and/or services. The contact center 102 can be hardware, software, or a combination of hardware and software. The contact center 102 can be executed by one or more servers or computer systems, as described in conjunction with FIGS. 5 and 6. The contact center 102 can include all systems, whether hardware or software, which allows the contact center 102 to receive, service, and respond to directed and automatically-retrieved contacts. For example the contact center 102 can include the telephone or email system, the interface to human agents, systems to allow human agents to service and respond to received contacts, and one or more systems operable to analyze and improve the function of agent interaction.

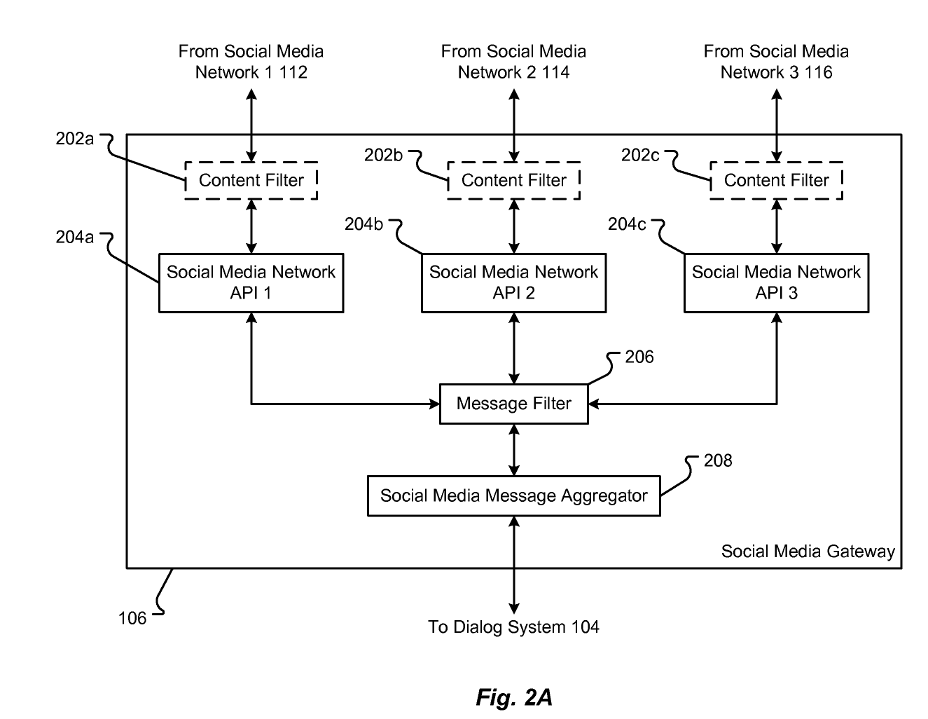

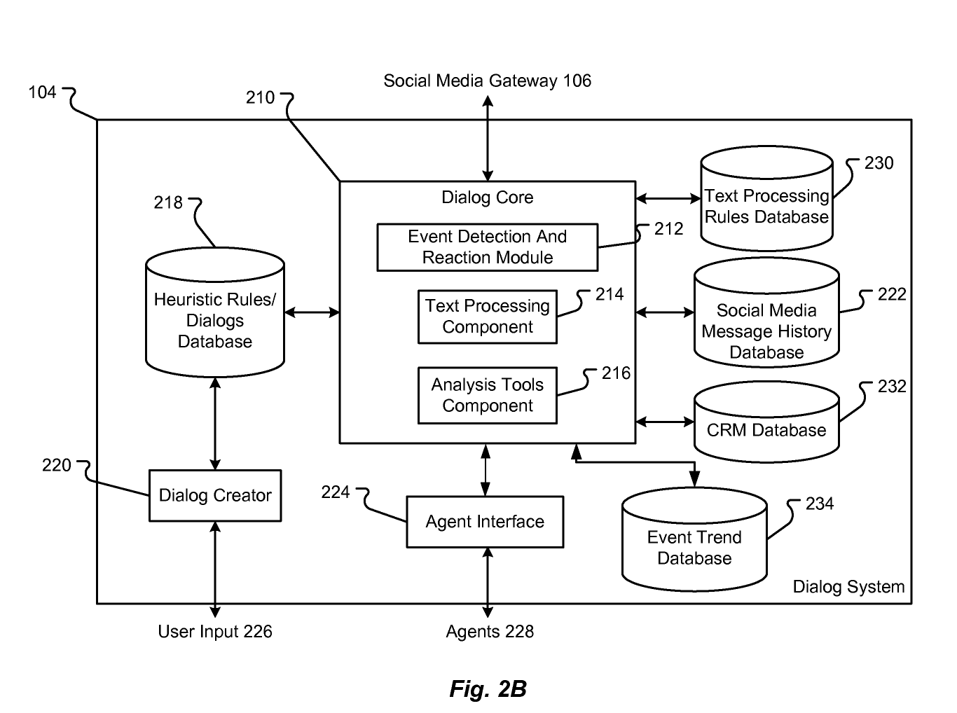

The contact center 102 may include a dialog system 104 and a social media gateway 106. While the dialog system 104 and the social media gateway 106 are shown as being a part of the contact center 102, in other embodiments, the dialog system 104 and/or the social media gateway 106 are separate systems or functions executed separately from the contact center 102 and/or executed by a third party. The dialog system 104 may process and receive messages. The social media gateway 106 can receive and translate messages from the one or more social media networks 112, 114, and/or 116. An embodiment of the dialog system 104 is described in conjunction with FIG. 2B. An embodiment of the social media gateway 106 is described in conjunction with FIG. 2A.

The contact center 102 may also communicate with one or more communication devices 110. The communication devices 110 can represent a customer's or user's cell phone, email system, personal digital assistant, laptop computer, or other device that allows the contact center 102 to interact with the customer. The contact center 102 can modify a non-direct contact, from a social media network 112, 114, and/or 116, into a directed contact by sending a response message directly to a customer's communication device 110.

An embodiment of the social media gateway 106 is shown in FIG. 2A. The social media gateway 106 can include one or more components which may include hardware, software, or combination of hardware and software. The social media gateway 106 can be executed by a computer system such as those in conjunction with FIGS. 5 and 6. However, in other embodiments, the components described in conjunction with FIG. 2A are logic circuits or other specially-designed hardware that are embodied in a field programmable gate array (FPGA).

Herein, the social media gateway 106 can include one or more content filters 202a, 202b, and/or 202c. A content filter 202 can receive all of the messages for the contact center 102 from a social media network 112, 114, and/or 116 and eliminate or delete those messages that do not require a response or relate to a particular customer survey. For example, a message between two friends on a Facebook page, if not pertaining to a product or a service of the company operating the contact center 102, may not need a response. However, such a message may be analyzed to determine if an event has occurred. Depending upon the context and/or content of the message, the content filter 202 can filter out or delete a non-suitable message from the messages that are received by social media network application programming interface (API) 1 204a, social media network API 2 204b, and/or social media network API 3 204c. With the content filter 202, the social media network API 204 only needs to translate those messages that should be received by the dialog system 104. Translation typically requires the conversion of the message or message text into a different format.

The content filter 202 is provided with one or more heuristics for filter rules from a filter database (not shown). These filter rules can be created by the external customer or internal user (e.g. agent or administrator) of the communication system 100. Thus, the user or customer of the communication system 100 can customize the filtering of messages from social media networks 112, 114, and/or 116. Further, different rules may be applied to different social media networks, as some social media networks may have different types of messages or postings than other types of social media networks.

While the content filter 202 is shown as part of the social media gateway 106, it is to be appreciated that the content filter 202 may be a part of the social media network API 204. The content filter 202 may correspond to the query terms used by the social media network API 204. The content filter 202 or query terms are an argument to the social media network API 204 call. The social media network API 204 can be an application that the social media network 112, 114, and/or 116 provides to access the site. Thus, the social media network API 204 is called and connects the social media gateway 106 to the social media network 112, 114, and/or 116. Any suitable filter criteria may be employed. Examples include social media identifier (i.e., the known social media identifier of a customer of the enterprise that operates the contact center 102), content of source, address field, destination or recipient address fields, time stamp field, subject matter field, and message body field. For example, an obvious searchable content is the name of the business enterprise running the contact center 102 and/or products or services of the enterprises. Other searchable content may correspond to keywords related to forces of nature, acts of god, terrorist activities, extreme events, dangerous conditions, traffic conditions, and the like.

The social media gateway 106 can include one or more social media network API 204. As shown in FIG. 2A, the social media gateway 106 may include a social media network API 204 for each social media network 112, 114, and/or 116. As such, the social media gateway 106 can interact with each social media network 112, 114, and/or 116 in the particular (often unique) format or protocol used by the social media network 112, 114, and/or 116. Further, when new social media networks are created, the social media gateway 106 can easily be expanded to interact with those social media networks by adding another social media network API 204. Where social media networks 112, 114, and/or 116 are more standardized, or use substantially similar formats or protocols, a single social media network API can be shared by multiple such social media networks 112, 114, and/or 116.

The social media network API 204 can receive messages from and send messages corresponding to the social media network 112, 114, and/or 116. The social media network API 204 can translate a message received from a social media network 112, 114, and/or 116 and send the translated message to a message filter 206. The social media network API 204 can translate the received message into a standard formatted file. For example, the translated message may be represented by an extensible mark-up language (XML) file or other file having a general format. As such, each specific and particular social media network message can be translated into a standard format for use by the dialog system 104. Further, the social media network API 204 can receive a generally or standard format response message, from the dialog system 104 and translate that response into a particularly or specifically formatted response message that can be posted to the corresponding social media network 112, 114, and/or 116.

Messages to the contact center 102 are addressed to the contact center 102. For example, a customer may become a “friend” of the contact center 102 on a social media network 118, such as Facebook. The customer may then address a message to the contact center 102 on Facebook. This non-direct contact is a message that is not sent directly to the contact center 102 but to the contact center's Facebook page. In other embodiments, the contact center 102 receives messages not addressed to the contact center 102. For example, the contact center 102 can receive tweets from Twitter that are “broadcast” rather than addressed to the contact center 102 or messages between social network users. The contact center 102 may also search for message or content on the social media network 112, 114, and/or 116. The search criteria used to search for events and the like may be explicitly provisioned or dynamically provisioned. An explicitly provisioned search term may include keywords that are potentially related to an event that the contact center 102 is interested in. A dynamically provisioned search term may be generated by first determining a normal frequency with which a keyword occurs. Such “normal frequencies” may be determined for a large number of different keywords or key phrases. Normal frequencies can be determined for all users or for a subset of users. For example, one social media network may have a first normal frequency of occurrence for a keyword whereas another social media network may have a second normal frequency of occurrence for the same keyword, where the first and second normal frequencies are different. These differences may account for the nature and character of the different social media networks 112, 114, and 116. For example, one social media network may correspond to a business-use-type social media network whereas another social media network may correspond to a personal-use-type social media network. Alternatively, all social media networks 112, 114, 116 may have the same normal frequency of occurrence.

Such normal frequencies of occurrence may be explicitly provisioned, thereby allowing the content filter 202 to allow such messages through for further analysis, but do not constitute an explicit search criteria. The system may then monitor the frequency with which such keywords occur over a particular period to determine if the actual frequency of occurrence has deviated from the normal frequency by some predetermined amount (e.g., +/−5% change from the normal frequency of occurrence). If the system determines that the actual frequency of occurrence has deviated from the normal frequency, then the system may incorporate that keyword or key phrase into the search terms that are used to analyze the social media networks 112, 114, and/or 116. Detection of such an occurrence may also result in the system generating responses to any social media posting that includes the keyword or key phrase satisfying the search criteria. In some embodiments, however, the generation of responses may be conditioned upon further analysis by the dialog system 104.

Likewise, when the system detects that the actual frequency of occurrence has come back within the range considered normal, then the dynamic search criteria may be eliminated. This may occur in one of several ways. First, the actual frequency of occurrence may change back to the original normal range. Second, the normal frequency may be re-provisioned to reflect a new normal. Combinations of the above may also cause the dynamic search criteria to be eliminated.

Thus, the social media gateway 106 of the contact center 102 can query, gather, or connect to a live feed of data from a social media network 112, 114, and/or 116 and then apply a filter to the indirect information.

The translated messages from the social media network API 204 can be received by a message filter 206. A message filter 206 can perform some or all of the functions of the content filter 202 and eliminate messages before being sent to the dialog system 104. However, in other embodiments, the message filter 206 eliminates information from within the messages before the trimmed messages are sent to the dialog system 104. For example, a message from a social media network 116 may have three or four interactions between two parties not associated with the contact center 102. Only one of the several postings may be pertinent to the dialog system 104. As such, the message filter 206 can eliminate or delete at least a portion of the other messages for the dialog system 104. Thus, the dialog system 104 receives a message where some of the content of the message has been deleted. The message filter 206 can retrieve heuristics or filter rules from a filter database (not shown), similar to the content filter 202. A substantial difference between the content and message filters 202 and 206 is that the content filter 202 is specific to a particular message format associated with a corresponding social media network 112, 114, and/or 116, while the message filter 206 is applied to a standardized or universal format and is therefore common to multiple social media networks 112, 114, and/or 116. One skilled in the art will understand the type of rules that may be used to filter information from messages such that only pertinent questions, facts, requests, or information is sent to the dialog system 104.

A message aggregator 208 may also be included with the social media gateway 106. A message aggregator 208 can, in contrast to the message filter 206, combine two or more messages into a packet or grouping that is sent to the dialog system 104. Therefore, the message aggregator 208 can inter-relate or combine messages based on different information within the messages. For example, two messages may be combined based on any of the message fields referenced above, such as the person that posted the message, the subject, the request or question asked, the person the message was sent to, the event with which the messages are potentially associated with, or other information that may be pertinent to the dialog system 104. Thus, the dialog system 104 may be able to respond concurrently to two or more messages based on a grouping provided by the message aggregator 208. If the messages are aggregated or not aggregated, each message can be sent from the social media gateway 106 to the dialog system 104.

The social media gateway 106 can also send responses back to the social media networks 112, 114, and/or 116. A response from an agent in the contact center 102 can be sent to the social media gateway 106. The response may be in a general format and translated. The translated response may then be posted to the appropriate social media network 112, 114, and/or 116 by the social media gateway 106. In other embodiments, the agent may post the response directly to the social media network 112, 114, and/or 116 without sending the response to the social media gateway 106.

An embodiment of the dialog system 104 is shown in FIG. 2B. The dialog system 104 can include one or more components which may be hardware, software, or combination of hardware and software. The dialog system 104 can be executed by a computer system such as those described in conjunction with FIGS. 5 and 6. However, in other embodiments, the components described in conjunction with FIG. 2B, are logic circuits or other specially-designed hardware that are embodied in a field programmable gate array (FPGA) or application specific integrated circuit (ASIC). The components contained within the dialog system 104 can include a dialog core 210 that is communication with a message history database 222, an agent interface 224, and a heuristic rules and dialogs database 218. Further, the heuristic rules and dialogs database 218 can be in communication with a dialog creator 220.

The dialog core 210 can include one or more sub-components. For example, the dialog core 210 includes an event detection and reaction module 212, a text processing component 214, and an analysis tools component 216. These components, similar to the components for the dialog system 104, can be hardware, software, or combination of hardware and software. The dialog core 210 steps through the states of a data structure. A dialog is a set of inputs and associated actions that can be taken which allow for the automatic and structured response to social media requests or messages as well as the automatic and structured response to negative social media feedback. For example, if an event related to a software bug is detected, the input of the text word “bug” along with the text word corresponding to the software product in question can cause the dialog system 104 to send information about one or more manuals, plugins, patches, or the like.

The data structure allows the dialog core 210 to automate the interaction between the contact center 102 and a person. This automation eliminates the need for agent involvement, in some situations, and makes the contact center 102 more efficient and more effective. Further, the automation expands the contact center's ability to answer numerous messages and respond to events from the plethora of postings on the numerous social media networks 112, 114, and/or 116.

The dialog creator 220 will create a data structure 300 that steps through various states for each social media message that comes into the contact center 102. The first step might be to send the social media message to the event detection and reaction module 212, then to the text processing component 214, and then execute a query of a Customer Relationship Management (CRM) system and a CRM database 232 (to find out if this user has an existing order). A CRM database 232 can store information about customers or other data related to customer relations. Finally the data structure might decide that the social media message should be sent to a human agent 228 for processing. The CRM database 232 may be the same or similar to the tracker database 110 in that the CRM database 232 can store information regarding customers of the contact center 102. The states or node transitions are in the dialog core 210 and make use of many different components that the dialog creator 220 combines in any way the user desires to handle the social media messages. The dialog core 210 can make use of the survey component 212, text processing component 214, or other systems. The dialog core 210 may also interface with a CRM system and/or CRM database 232, external databases, social media user information (e.g., followers, friends, post history, etc. from the social media site), or other systems.

The event detection and reaction module 212 is operable to perform a number of functions on a received work item or collection of received work items. In accordance with some embodiments, the event detection and reaction module 212 is configured to detect the occurrence of an event by analyzing messages received from various different information sources (i.e., the social media networks 112, 114, and/or 116). In some embodiments, the event detection and reaction module 212 is responsible for managing information in an event trend database 234, which stores normal frequencies of occurrence for one or more keywords or key phrases. The event detection and reaction module 212 can analyze the frequency with which certain words or phrases are being used in social media messages and other public message forums. In particular, the filters 202 described in connection with FIG. 2A may allow any message to the dialog system 104 if a keyword or key phrase identified in the event trend database 234 is detected within that message. The event detection and reaction module 212 is then responsible for analyzing all such messages to determine if an event has occurred. Events which are detected by the event detection and reaction module 212 are generally events which are of-interest to the enterprise administering the contact center 102. Such events are detectable based on the occurrence of keywords or key phrases in the event trend database 234.

As discussed above, the event detection and reaction module 212 may be configured to detect an event by detecting that keyword or key phrase utilization has deviated from the frequency range considered normal (as defined in the event trend database 234).

If the actual utilization deviates from the normal utilization, then the event detection and reaction module 212 may invoke its reaction functionality to begin determining suitable responses to the event. Such reaction functionality may include performing a more in-depth analysis of the messages containing the event-specific keyword or key phrase and determining whether any predefined responses are provided in the event trend database 234. Such predefined responses may be based on historical responses to similar events or they may be based on rules established for responding to certain types of events. For example, a predefined product-based event may include a typical response of requesting product name, purchase date, and other pertinent information from the user who posted the message. As another example, a predefined response may include transmitting a coupon or message indicating that an issue is being looked into, showing currently available data regarding the event or showing available data locations where such data can be retrieved.

The reaction functionality of the event detection and reaction module 212 may also include invoking other components of the dialog core 210 to generate a customized response to the messages related to the detected event. In particular the event detection and reaction module 212 may call one or both of the text processing component 214 and analysis tools component 216.

The text processing component 214 is operable to analyze text of one or more messages from social media networks 112, 114, and/or 116. Some possible methods for text processing can include Regular Expression, Latent Semantic Indexing (LSI), text part of speech tagging, text clustering, N-Gram document analysis, etc. In addition, for possibly longer documents, (such as, blogs or emails), the text processing component 214 may execute one or more methods of document summarization. The summarization may occur if the social media message will be sent to an agent 228 of the contact center 102; the summarization can reduce the amount of information that the agent may manage. The text processing rules or models may be stored in and/or retrieved from a text processing rules database 230 or the event trend database 234. The text processing rules database 230 can be a database as described in conjunction with FIGS. 5 and 6 that stores rules or models used by the text processing component 214.

The text processing component 214 can be utilized by the event detection and reaction module 212 to identify one or more occurrences of a particular text, such as using one or more of the message fields referenced above, in order to associate that social media message with one or more dialogs data structures in the heuristic rules and dialog database 218 or events in the event trend database 234. For example, the text processing component can look for the word “tornado,” in the social media message. If the word “hurricane” is found, the text processing component 214 may retrieve a dialog from the heuristic rules and dialogs database 218, which communicates with the customer about one or more recommended methods of preparing for a tornado. In another example, if the social media message includes the words, “buy”, “sell”, “price, “discount” or other types of words that may indicate the user or customer wishes to buy a product, the text processing component 214 can retrieve one or more dialogs from the heuristic rules and dialogs database 218 that can assist the customer in purchasing products or services from the enterprise.

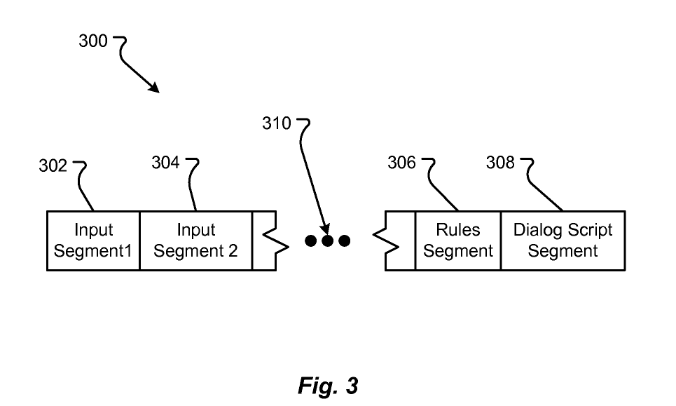

The analysis tools component 216 is operable to analyze response messages received back from an agent interface 224. In analyzing the agent's responses, the analysis tools component 216 can determine if the data structures 300 (FIG. 3) originally retrieved by the text processing component 214 met the needs of the event. The analysis tools component 216 may also be configured to determine whether a data structure 300 generated in response to an event is sufficient for responding to the event and, if so, store such responses in the event trend database 234.

Thus, the analysis tools component 216 can provide information to the dialog core 210 or the dialog creator 220 to improve the data structures 300 (FIG. 3) that are included in the heuristic rules and dialogs database 218. Additionally, the analysis tools component 216 can maintain and organize data contained with the event trend database 234 to ensure that timely and proper responses to event can be generated and disseminated to affected and potentially affected persons.

The message history database 222 can be any database or data storage system as described in conjunction with FIGS. 5 and 6. Likewise, the event trend database 234 can be any database or data storage system as described in conjunction with FIGS. 5 and 6. In some embodiments, the contents of the message history database 222 and the event trend database 234 are combined into a single database. Thus, the message history database 222 and/or event trend database 234 can store data in data fields, objects, or other data structures to allow other systems to retrieve that information at a later time. The message history database 222 can store previous messages or information about previous messages.

The heuristic rules and dialogs database 218 can be any type of database or data storage system as described in conjunction with FIGS. 5 and 6. The heuristic rules and dialogs database 218 can store information and data fields, data objects, and/or any other data structures. An example of information stored within the heuristic rules and dialogs database 218 is described in conjunction with FIG. 3. The heuristic rules and dialogs database 218 stores rules and dialogs that automate responses to received social media messages. The dialogs control the interaction between the dialog core 210 and the social media network 112, 114, and/or 116. The dialogs or heuristic rules can be created by a dialog creator 220. Thus, the dialog creator 220 can interface with the user input 226 to receive information about dialogs. The user input 226 is then used to form the states and responses for a dialog.

An agent interface 224 is a communication system operable to send action items to contact center agents, in the contact center 102. An agent can be a person or other system that is operable to respond to certain questions or requests from a customer. For example, the agent can be a person that has specialized expertise in a topic area, such as technical support. The agent interface 224 can format the social message into an action item and forward that message to one or more agents 228. The agent interface 224 can also receive response(s) back from the agents 228. The information provided by the agent may be used by the dialog core 210 to complete a response to the social media message. For example, the information may classify the social media message (e.g., sales, service, etc.). In other embodiments, the response is a complete response to the social media message that can be posted to the social media network 112, 114, and/or 116.

An embodiment of a data structure 300 is shown in FIG. 3. The data structure 300 can be stored in several different forms of databases, such as relational databases, flat files, object-oriented databases, etc. Thus, while the term “data field” or “segment” is used, the data may be stored in an object, an attribute of an object, or some other form of data structure. Further, the data structure 300 can be stored, retrieved, sent, or received during the processing of dialogs by the dialog core 210 or the dialog creator 220. The data structure 300 stores one or more items of information in one or more data fields. The numeric identifiers (e.g. 302, 304, etc.) shown in FIG. 3 can identify, in one or more fields or segments, either the data field or segment or the data stored in the data field or segment.

The data structure 300 can include one or more input segments, such as, input segment 1 302 and input segment 2 304, a rules segment 306, and/or a dialog script segment 308. Input segments 302 and 304 each include one or more fields comprising the one or more inputs that may be required to associate a social media message, a classification thereof, or an event associated therewith the data structure 300. The inputs segments 302 and 304 may include a customer identity, a respective customer type, a text word, a phrase, a number of text words, a product name, a service description, a customer's social media identifier, or other information that indicates that the data structure 300 is associated with the social media messages. Alternatively, or in addition, the input segments 302 and 304 may include event detection variables (e.g., normal frequencies, frequency thresholds, etc.) to determine whether the data structure 300 is to be invoked based on the detection of an event or whether an event has been detected. While there are only two input segments 1 302 and 2 304 shown in FIG. 3, there may be more or fewer input segments associated with the data structure 300, as indicated by ellipses 310.

The rules segment 306 can include one or more heuristic rules that either help with the association of the respective data structure 300 with the social media message or control the interaction between the dialog core 210 and the social media customer or between the dialog core 210 and the agents 228. For example, the rule 306 can state that the data structure 300 applies only if the social media message includes input segment 1 302 but not input segment 2 304. One skilled in the art will be able to identify other types of rules that may govern the association of the data structure 300 with the social media message or a group of social media messages. In other embodiments, the rules segment 306 states that if the social media message includes inputs 1 302 and/or 2 304, then the dialog core 210 should respond with a certain type of action, which may be defined within other segments of the data structure 300, such as the dialog script segment 308.

Generally, a dialog script segment 308 includes a script of actions or responses that direct one or more other components, such as the dialog core 210 (FIG. 2B), to conduct the actions or send the responses. The dialog script segment 308 can include the one or more responses required by the dialog core 210. If the dialog script segment 308 applies (that is, if the social media message is requesting a certain type of information), the dialog script segment 308 may include the one or more responses that the dialog core 210 should communicate to respond to that social media message, classify a social media message as being related to an event, or the like. Alternatively, or in addition, the dialog script segment 308 may include information for generating automated responses for responding to a message related to an event. The dialog script segment 308 can also include a response and a pointer to another dialog script segment 308 or another data structure 300. Further, the dialog script segment 308 may have one or more actions that may be taken by another component after a secondary response is received by a customer or after a response is posted by an agent 228.

It should be noted that the dialog script segment 308 can reference one or more other data structures 300. Thus, the dialog script segment 308 can direct the dialog core 210 to reference at least one other data structure 300 to further act on the social media message or catalog previous responses for future use. Further, the social media message can be subject of two or more dialog script segments 308, and direct the dialog core 210 to complete two dialog script segments on the social media message. Also, dialog script segments 308 may not be associated with a response but direct the dialog core 210 to complete other actions, such as populating databases or gathering information.

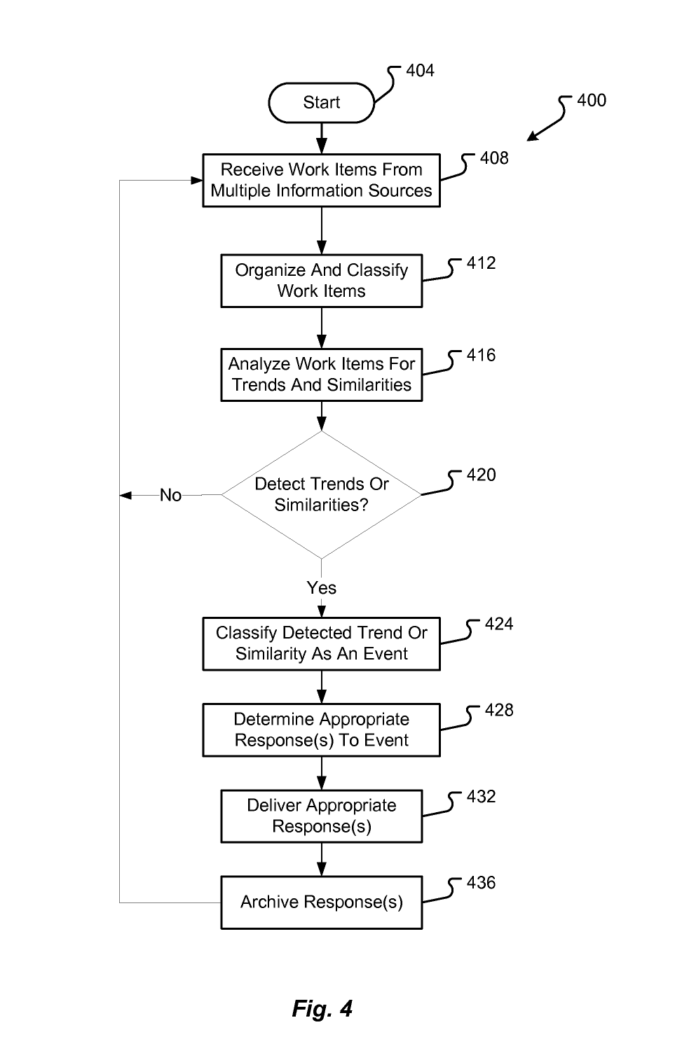

Referring now to FIG. 4, an exemplary method 400 of detecting and responding to events via a social media interaction will be described. The method 400 begins in step 404 and continues when work items are received from multiple information sources (step 408). Such information sources may include the social media networks 112, 114, and/or 116 and the work items may correspond to messages received from the information sources.

Thereafter, the work items are organized and classified based on their content and/or context (step 412). The organization and classification may be based on keywords and other known conditions. For example, if two separate work items contain one common key word or two different but related keywords, such as synonyms (e.g., one work item contains “stock price” and another work item contains “market price”), then those work items may be classified and organized in a common manner. Other methods of classifying and organizing work items may include classifications based on location of the user who posted the social media message, time at which the social media message was posted, identity of the user who posted the social media message, whether users have a pre-existing relationship (e.g., are friends or connected on the social media platform), and so on.

The method continues with the work items being analyzed for certain trends and similarities (step 416). As can be appreciated, the organization, classification, and analysis steps may be performed at the same time or the analysis step may be performed before the classification step. Based on the analysis of the work items for trends and similarities, the event detection and reaction module 212 determines if any trends or similarities have been detected which correspond to the detection of an event (step 420). The satisfaction of one or more common conditions may result in two or more work items being commonly organized and classified together and being further associated with a common event. Alternatively, or in addition, the detection of the change with which one or more keywords or key phrases are used may result in the detection of an event.

If the query of step 420 is answered negatively, then the method returns to step 408. Otherwise, the method 400 continues with the event detection and reaction module 212 classifying the detected trend or similarity as a particular event (step 424). The classification may be based on predetermined classification definitions provided in the event trend database 234. Alternatively, if the event does not fall within the definition of any predetermined event, then the event detection and reaction module 212 may classify the event as a new and un-classified event.

Thereafter, the method 400 continues with the event detection and reaction module 212 determining one or more appropriate responses to the event (step 428). Again, these responses may be stored within the event trend database 234 as part of a data structure 300. In some embodiments, responses are completely automated and executed by the dialog system 104. In some embodiments, responses include transferring the work item or group of work items to an agent 228 so that a human-based and custom response can be generated for the work item or group of work items belonging to the common event. In some embodiments, the response may include a hybrid of an automated response and a custom human-generated response.

Once the response(s) have been determined and generated, the response(s) are delivered to one or more persons or parties known to be affected by the event or presumed to be affected by the event (step 432). Persons known to be affected by the event may include persons that posted a social media message which was transformed into a work item which resulted in the detection of the event as well as persons that have subsequently posted a social media message which was transformed into a work item at the contact center 102 and that work item also qualified for classification with other work items and the event. Persons presumed to be affected by the event may include persons within a known proximity of an event. Such proximity may be physical or logical. Physical proximity may be based on a determined location of the event and a location of the person whereas logical proximity is based on a context of the event and a person's known or presumed interest in the event, based on information contained within the CRM database 232.

Following delivery of the response(s), the response(s) are archived in the event trend database 234 such that they can be subsequently used for future events which are similar or identical to the event which was recently responded to (step 436). Thereafter, the method 400 returns to step 408.

FIG. 5 illustrates a block diagram of a system 500 that may function as servers, computers, or other systems provided herein. The system 500 includes one or more user computers 505, 510, and 515. The user computers 505, 510, and 515 may be general purpose personal computers (including, merely by way of example, personal computers, and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 505, 510, 515 may also have any of a variety of applications, including for example, database client and/or server applications, and web browser applications. Alternatively, the user computers 505, 510, and 515 may be any other electronic device, such as a thin-client computer, Internet-enabled mobile telephone, and/or personal digital assistant, capable of communicating via a network 520 and/or displaying and navigating web pages or other types of electronic documents. Although the exemplary system 500 is shown with three user computers, any number of user computers may be supported.

System 500 further includes a network 520. The network 520 may can be any type of network familiar to those skilled in the art that can support data communications using any of a variety of commercially-available protocols, including without limitation SIP, TCP/IP, SNA, IPX, AppleTalk, and the like. Merely by way of example, the network 520 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 502.11 suite of protocols, the Bluetooth™ protocol known in the art, and/or any other wireless protocol); and/or any combination of these and/or other networks. The network 520 may be the same or similar to network 105.

The system may also include one or more server computers 525, 530. One server may be a web server 525, which may be used to process requests for web pages or other electronic documents from user computers 505, 510, and 520. The web server can be running an operating system including any of those discussed above, as well as any commercially-available server operating systems. The web server 525 can also run a variety of server applications, including SIP servers, HTTP servers, FTP servers, CGI servers, database servers, Java servers, and the like. In some instances, the web server 525 may publish operations available operations as one or more web services.

The system 500 may also include one or more file and or/application servers 530, which can, in addition to an operating system, include one or more applications accessible by a client running on one or more of the user computers 505, 510, 515. The server(s) 530 may be one or more general purpose computers capable of executing programs or scripts in response to the user computers 505, 510 and 515. As one example, the server may execute one or more web applications. The web application may be implemented as one or more scripts or programs written in any programming language, such as Java™, C, C#™, or C++, and/or any scripting language, such as Perl, Python, or TCL, as well as combinations of any programming/scripting languages. The application server(s) 530 may also include database servers, including without limitation those commercially available from Oracle, Microsoft, Sybase™, IBM™ and the like, which can process requests from database clients running on a user computer 505.

The web pages created by the web application server 530 may be forwarded to a user computer 505 via a web server 525. Similarly, the web server 525 may be able to receive web page requests, web services invocations, and/or input data from a user computer 705 and can forward the web page requests and/or input data to the web application server 730. In further embodiments, the server 530 may function as a file server. Although for ease of description, FIG. 5 illustrates a separate web server 525 and file/application server 530, those skilled in the art will recognize that the functions described with respect to servers 525, 530 may be performed by a single server and/or a plurality of specialized servers, depending on implementation-specific needs and parameters. The computer systems 505, 510, and 515, file server 525 and/or application server 530 may function as the system, devices, or components described in FIGS. 1-3.

The system 500 may also include a database 535. The database 535 may reside in a variety of locations. By way of example, database 535 may reside on a storage medium local to (and/or resident in) one or more of the computers 505, 510, 515, 525, 530. Alternatively, it may be remote from any or all of the computers 505, 510, 515, 525, 530, and in communication (e.g., via the network 520) with one or more of these. In a particular set of embodiments, the database 535 may reside in a storage-area network (“SAN”) familiar to those skilled in the art. Similarly, any necessary files for performing the functions attributed to the computers 505, 510, 515, 525, 530 may be stored locally on the respective computer and/or remotely, as appropriate. In one set of embodiments, the database 535 may be a relational database, such as Oracle 10i™, that is adapted to store, update, and retrieve data in response to SQL-formatted commands.

FIG. 6 illustrates one embodiment of a computer system 600 upon which the servers, computers, or other systems or components described herein may be deployed or executed. The computer system 600 is shown comprising hardware elements that may be electrically coupled via a bus 655. The hardware elements may include one or more central processing units (CPUs) 605; one or more input devices 610 (e.g., a mouse, a keyboard, etc.); and one or more output devices 615 (e.g., a display device, a printer, etc.). The computer system 600 may also include one or more storage devices 620. By way of example, storage device(s) 620 may be disk drives, optical storage devices, solid-state storage devices such as a random access memory (“RAM”) and/or a read-only memory (“ROM”), which can be programmable, flash-updateable and/or the like.

The computer system 600 may additionally include a computer-readable storage media reader 625; a communications system 630 (e.g., a modem, a network card (wireless or wired), an infra-red communication device, etc.); and working memory 640, which may include RAM and ROM devices as described above. In some embodiments, the computer system 600 may also include a processing acceleration unit 635, which can include a DSP, a special-purpose processor, and/or the like.

The computer-readable storage media reader 625 can further be connected to a computer-readable storage medium, together (and, optionally, in combination with storage device(s) 620) comprehensively representing remote, local, fixed, and/or removable storage devices plus storage media for temporarily and/or more permanently containing computer-readable information. The communications system 630 may permit data to be exchanged with the network 620 and/or any other computer described above with respect to the system 600. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system 600 may also comprise software elements, shown as being currently located within a working memory 640, including an operating system 645 and/or other code 650, such as program code implementing the application server 530. It should be appreciated that alternate embodiments of a computer system 600 may have numerous variations from that described above. For example, customized hardware might also be used and/or particular elements might be implemented in hardware, software (including portable software, such as applets), or both. Further, connection to other computing devices such as network input/output devices may be employed.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the invention have been described in detail herein, it is to be understood that the inventive concepts may be otherwise variously embodied and employed, and that the appended claims are intended to be construed to include such variations, except as limited by the prior art.

What is claimed is:

1. A method, comprising:
receiving a plurality work items in a contact center;
analyzing the plurality of work items for trends or similarities;
detecting a trend or similarity among the plurality of work items;
classifying the trend or similarity as an event; and
generating a response to the event, wherein the response to the event is incorporated into a response to each of the plurality of work items.

2. The method of claim 1, wherein the plurality of work items are received from multiple information sources.

3. The method of claim 1, wherein a first of the plurality of work items is received from a first social media network and wherein a second of the plurality of work items is received from a second social media network.

4. The method of claim 3, wherein first social media network utilizes a different communication protocol than the second social media network.

5. The method of claim 1, wherein detecting a trend or similarity among the plurality of work items comprises detecting a common keyword or key phrase included in each of the plurality of work items.

6. The method of claim 1, wherein detecting a trend or similarity among the plurality of work items comprises:
determining a normal frequency with which a first keyword or key phrase is used on a social media network; and
detecting that an actual frequency with which the first keyword or key phrase occurs on the social media network falls outside of a normal threshold which is based on the normal frequency.

7. The method of claim 6, wherein the keyword or key phrase includes a word related to one or more of market conditions, forces of nature, acts of god, terrorist activities, extreme events, dangerous conditions, and traffic conditions.

8. The method of claim 1, wherein the response includes an automatically-generated response that is generated based on instructions contained in a dialog script segment of a data structure.

9. The method of claim 8, wherein response also includes a manually-generated response that is generated by a human contact center agent, the method further comprising:
delivering responses to each of the plurality of work items;
identifying other persons that have not generated a work item within the plurality of work items but are potentially affected by the event; and
delivering responses to each of the persons potentially affected by the event.

10. The method of claim 9, further comprising:
archiving the response which includes the contact center agent response in an event trend database along with a link to the classification of the event.

11. A computer readable medium having stored thereon instructions that cause a computing system to execute a method for responding to a work item, the instructions comprising:
instructions configured to analyze a plurality of work items received in a contact center for trends or similarities;
instructions configured to detect a trend or similarity among the plurality of work items;
instructions configured to classify the trend or similarity as an event; and
instructions configured to generate a response to the event, wherein the response to the event is incorporated into a response to each of the plurality of work items.

12. The method of claim 11, wherein the plurality of work items are received from multiple information sources.

13. The method of claim 11, wherein the instructions configured to detect a trend or similarity among the plurality of work items includes routines for determining a normal frequency with which a first keyword or key phrase is used on a social media network and detecting that an actual frequency with which the first keyword or key phrase occurs on the social media network falls outside of a normal threshold which is based on the normal frequency.

14. The method of claim 11, wherein the instructions further comprise:
instructions configured to deliver responses to each of the plurality of work items;
instructions configured to identify other persons that have not generated a work item within the plurality of work items but are potentially affected by the event; and
instructions configured to deliver responses to each of the persons potentially affected by the event.

15. A communication system comprising:
a social media gateway; and
a dialog core including an event detection and reaction module to analyze a plurality of work items received in a contact center for trends or similarities, detect a trend or similarity among the plurality of work items, classify the trend or similarity as an event, and generate a response to the event.

16. The communication system of claim 15, wherein the response to the event is incorporated into a response to each of the plurality of work items.

17. The communication system of claim 15, wherein the plurality of work items are received from multiple information sources.

18. The communication system of claim 15, wherein a first of the plurality of work items is received from a first social media network and wherein a second of the plurality of work items is received from a second social media network and wherein first social media network utilizes a different communication protocol than the second social media network.

19. The communication system of claim 15, wherein detecting a trend or similarity among the plurality of work items comprises detecting a common keyword or key phrase included in each of the plurality of work items.

20. The communication system of claim 15, wherein the event detection and reaction module is configured to determine a first normal frequency with which a first keyword or key phrase is used on a first social media network, determine a second normal frequency with which the first keyword or key phrase is used on a second social media network, and detect that an actual frequency with which the first keyword or key phrase occurs on either the first or second social media network falls outside of a normal threshold which is based on the first and second normal frequencies, respectively.
